(19) United States
(12) Patent Application Publication
(10) Pub. No.: US 2013/0069346 A1
(43) Pub. Date: Mar. 21, 2013

(54) INTERIOR ROOF RETAINER

(71) Applicant: Chrysler Group LLC, Auburn Hills, MI (US)

(72) Inventors: Shawn R. Williams, Auburn Hills, MI (US); Joseph G. Lemmon, Chesterfield, MI (US); Robert P. Kuhr, Farmington Hills, MI (US); Ryan A. Vaughan, Macomb, MI (US)

(73) Assignee: Chrysler Group LLC, Auburn Hills, MI (US)

(21) Appl. No.: 13/623,544

(22) Filed: Sep. 20, 2012

Related U.S. Application Data
(60) Provisional application No. 61/537,383, filed on Sep. 21, 2011.

(51) Int. Cl. B60R 21/16

(52) U.S. Cl. 280/728.2

(57) ABSTRACT

An airbag deployment system for a vehicle is provided. The airbag deployment system can include an airbag positioned between a vehicle frame and a headliner. The airbag deployment system can also include a retainer positioned along the headliner. The retainer can have a rib positioned and configured above the airbag. When the airbag is deployed, the rib can urge the airbag away from the rib in a direction of a lower, external side edge of the headliner, toward an interior portion of the vehicle.

### CROSS-REFERENCE TO RELATED APPLICATION

This application claims the benefit of U.S. Provisional Ser. No. 61/537,383, filed Sep. 21, 2011.

### FIELD

The present teachings relate to vehicle safety systems, and more particularly to an interior roof system for use with a side airbag.

### BACKGROUND

Many modern vehicles employ airbag systems as a form of passenger restraint. Typically, airbags serve to absorb the kinetic energy of a passenger generated during an impact event by inflating into a surface operable to contact the passenger to absorb the passenger's kinetic energy. Generally, airbag systems are positioned in various locations throughout the vehicle, such as the dashboard, steering wheel, sidewall of the passenger seat and the headliner. These airbag systems are usually hidden from view by various trim components. In certain instances, it can be desirable for airbag to be assembled with the headliner to reduce assembly time.

### SUMMARY

According to various embodiments, an airbag deployment system for a vehicle is provided. The airbag deployment system can include an airbag positioned between a vehicle frame and a headliner. The airbag deployment system can also include a retainer positioned along the headliner. The retainer can have a rib positioned and configured above the airbag. When the airbag is deployed, the rib can urge the airbag away from the rib in a direction of a lower, external side edge of the headliner, toward an interior portion of the vehicle.

Further provided is an interior roof retainer for a motor vehicle. The interior roof retainer can include a headliner that spans a passenger area in the motor vehicle. The interior roof retainer can also include at least one interior retainer coupled to the headliner so as to extend substantially along a length of the headliner. The at least one interior retainer can include at least one airbag retaining feature. The at least one airbag retaining feature can include at least one bracket and at least one flange. The interior roof retainer can also include at least one airbag capable of expanding through a portion of the headliner. A strap of the at least one airbag can be couplable to the at least one bracket and a portion of the at least one airbag can be received between the at least one flange and the headliner to couple the at least one airbag to the at least one interior retainer. The interior roof retainer can include at least one inflator that is operable to expand the at least one airbag. The at least one inflator can be couplable to the at least one interior retainer.

Further areas of applicability of the present disclosure will become apparent from the detailed description, drawings and claims provided hereinafter. It should be understood that the detailed description, including disclosed embodiments and drawings, are merely exemplary in nature intended for purposes of illustration only and are not intended to limit the scope of the invention, its application or use. Thus, variations that do not depart from the gist of the invention are intended to be within the scope of the invention.

### BRIEF DESCRIPTION OF THE DRAWINGS

FIG. 1 is a perspective view of a motor vehicle having an interior roof retainer according to an exemplary embodiment of the present disclosure;

FIG. 2 is a perspective view of the interior roof retainer of FIG. 1 coupled to a headliner;

FIG. 3 is a perspective view of a portion of the interior roof retainer of FIG. 1;

FIG. 4 is a cross-sectional view of the interior roof retainer of FIG. 1 taken along line 4-4 of FIG. 2, illustrating an airbag in a first, undeployed position;

FIG. 4A is a detail view of the interior roof retainer of FIG. 4, illustrating a directional rib; and

FIG. 5 is a cross-sectional view of the interior roof retainer of FIG. 1 taken along line 4-4 of FIG. 2, illustrating an airbag in a second, deployed position.

### DETAILED DESCRIPTION

In exemplary embodiments disclosed herein, an airbag deployment system for a vehicle is provided. The airbag deployment system can include an airbag positioned between a vehicle frame and a headliner. The airbag deployment system can also include a retainer positioned along the headliner. The retainer can have a rib positioned and configured above the airbag. When the airbag is deployed, the rib can urge the airbag away from the rib in a direction of a lower, external side edge of the headliner, toward an interior portion of the vehicle.

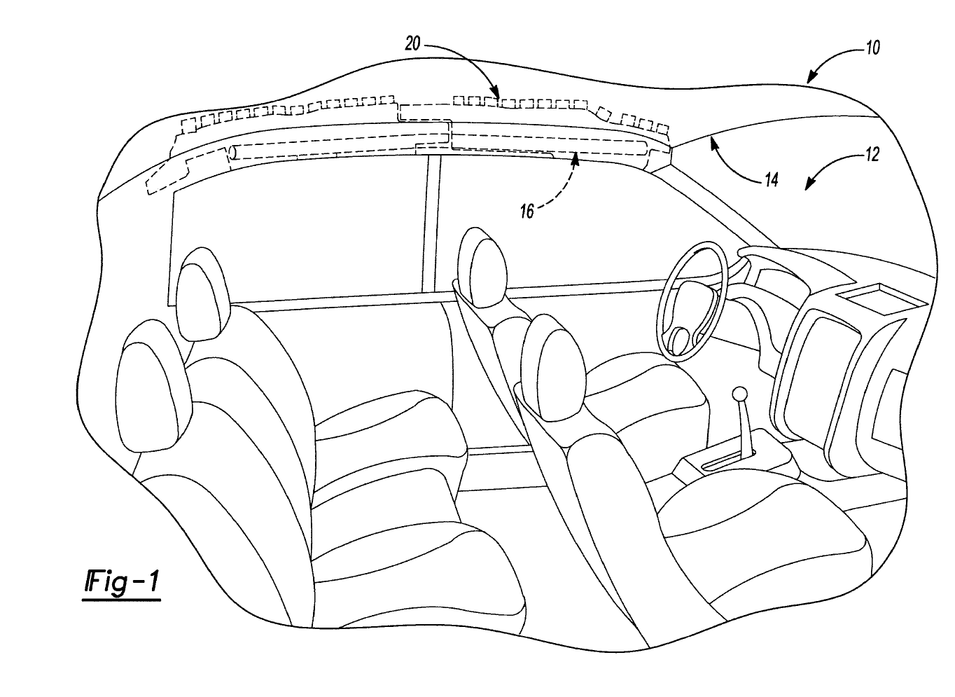

In an exemplary embodiment, with reference to FIGS. 1-5, a motor vehicle 10 is shown, which can include a passenger area 12 and a headliner 14. An overhead side airbag system 16 can be coupled to the headliner 14 by at least one interior retainer 20. It should be noted that the motor vehicle 10 illustrated and described herein is merely exemplary, as a motor vehicle incorporating the at least one interior retainer 20 could include some or more components than those illustrated herein. The at least one interior retainer 20 can couple the overhead side airbag system 16 to the motor vehicle 10. The headliner 14 can enable the overhead side airbag system 16 to inflate and expand into the passenger area 12 and can also provide an aesthetically pleasing environment for passengers within the passenger area 12.

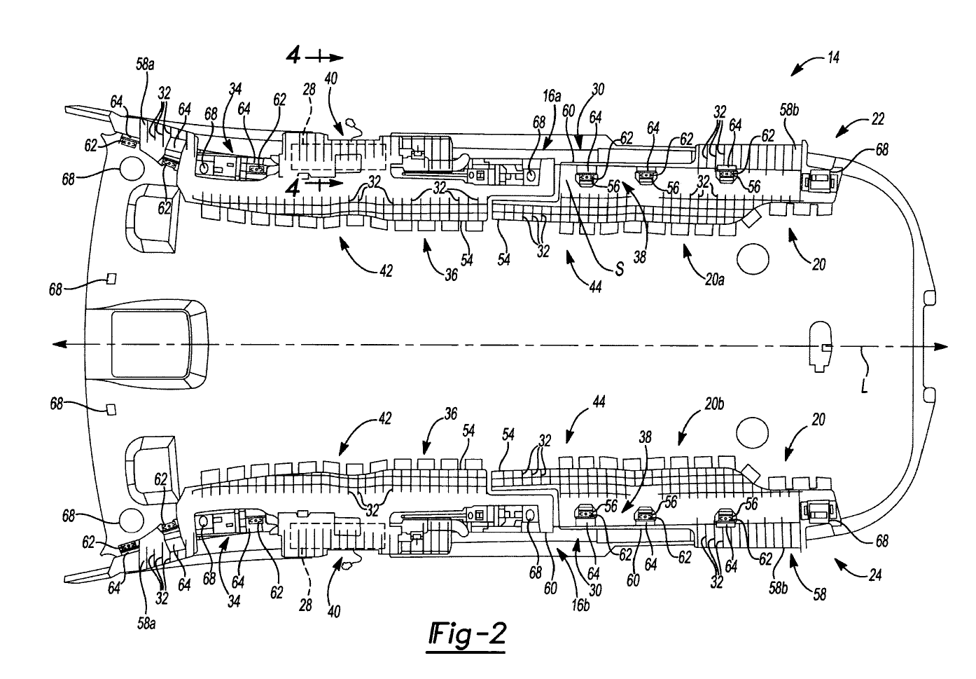

With reference to FIGS. 1 and 2, the headliner 14 can span the passenger area 12. With reference to FIG. 2, the headliner 14 can include a first side 22 opposite a second side 24. The at least one interior retainer 20 can be coupled to one of the first side 22 and the second side 24. In one example, the at least one interior retainer 20 can comprise a first interior retainers 20a and a second interior retainer 20b. The first interior retainer 20a can be coupled to the first side 22 and the second interior retainer 20b can be coupled to the second side 24. Generally, the interior retainers 20a, 20b can be coupled to the headliner 14 so as to extend along a longitudinal axis L defined by the headliner 14. The interior retainers 20a, 20b can extend substantially along an entire length of the headliner 14. The interior retainers 20a, 20b can be coupled to the headliner 14 such that the interior retainers 20a, 20b and the overhead side airbag system 16 are hidden from view in the passenger area 12. In other words, the headliner 14 can enclose the overhead side airbag system 16 (FIG. 1). During the inflation of the overhead side airbag system 16, the expanding overhead side airbag system 16 can move or push a lower, external side edge of the headliner 14 away from the motor vehicle 10 to enable the overhead side airbag system 16 to expand into the passenger area 12, as will be discussed further herein.

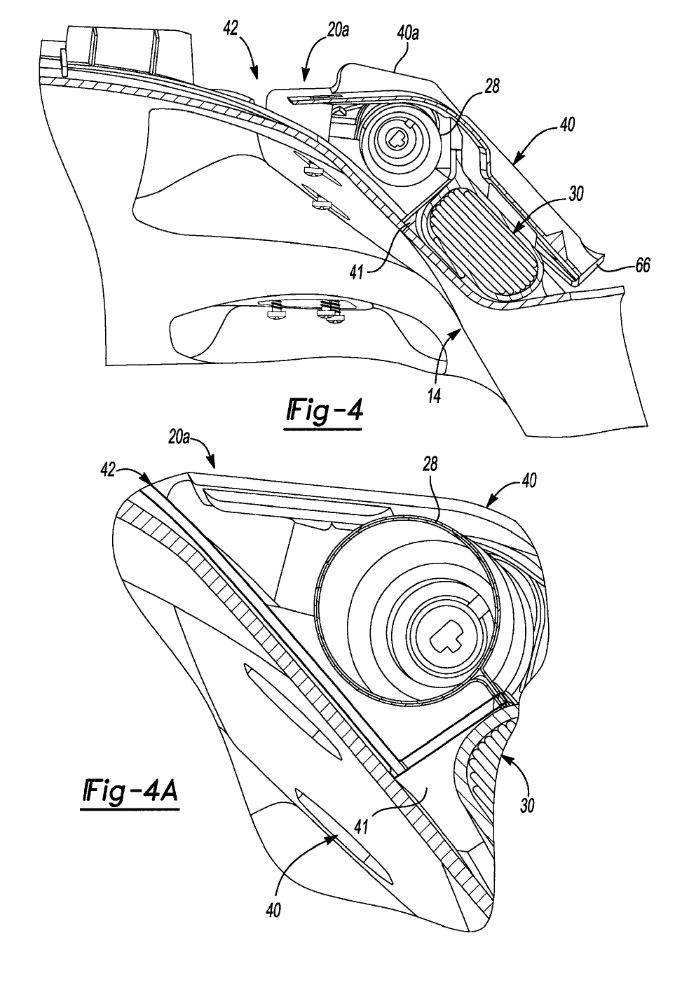

With reference to FIGS. 2 and 4, the overhead side airbag system 16 can comprise any suitable overhead side impact airbag system, and in one example, can include an inflator 28 and an airbag 30. One overhead side airbag system 16a can be coupled to the first interior retainer 20a, and one overhead side airbag system 16b can be coupled to the second interior retainer 20b. Thus, at least one inflator 28 and airbag 30 can be coupled to the first interior retainer 20a, and at least one inflator 28 and airbag 30 can be coupled to the second interior retainer 20b. With reference to FIG. 4, it should be noted that although the inflator 28 is illustrated herein as being cylindrical and the airbag 30 is illustrated herein as being oval in shape prior to inflation, the inflator 28 and airbag 30 can each have any desired shape, such as square, rectangular, oval, cylindrical, etc. In one example, the airbag 30 can comprise a side airbag inflatable curtain. The inflator 28 can be in communication with the airbag 30 or responsive to a signal to deploy or inflate the airbag 30. As will be discussed, as the airbag 30 deploys or inflates, the airbag 30 can push through the headliner 14 into the passenger area 12. The inflator 28 can be positioned between the respective interior retainer 20a, 20b and the frame of the motor vehicle 10.

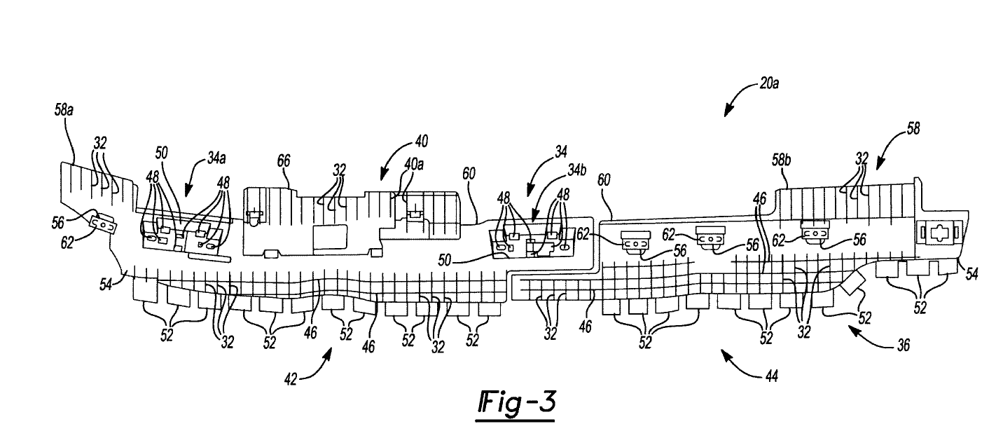

With reference to FIG. 2, the interior retainers 20a, 20b can couple the overhead side airbag system 16a, 16b to the headliner 14. As the interior retainers 20a, 20b can be substantially identical and symmetrical about the longitudinal axis L, only the first interior retainer 20a will be described in great detail herein, with the understanding that the second interior retainer 20b is substantially identical to the first interior retainer 20a. With reference to FIG. 3, the first interior retainer 20a can include one or more impact ribs 32, at least one handle mounting feature 34, at least one wire harness retainer 36, at least one airbag retaining feature 38 and an inflator cover 40. One or more of the impact ribs 32, at least one handle mounting feature 34, at least one wire harness retainer 36, at least one airbag retaining feature 38, the inflator cover 40 and a directional rib 41 can be formed on a first portion 42 and/or a second portion 44 of the first interior retainer 20a.

In this regard, the first interior retainer 20a can be composed of an injection molded thermoplastic material. Due to the size of the first interior retainer 20a, it can be desirable to form the first interior retainer 20a as the first portion 42 and the second portion 44. It should be noted, however, that the first interior retainer 20a can be integrally molded, if desired. Further, it should be noted that the first interior retainer 20a could be formed of more components than the first portion 42 and the second portion 44, if desired, for ease of assembly. Each of the first portion 42 and the second portion 44 can be coupled to the headliner 14 through a suitable technique, such as the use of an adhesive, mechanical fasteners, etc.

With reference to FIG. 3, the impact ribs 32 can be formed along the first portion 42 and the second portion 44. The impact ribs 32 can provide energy absorption in an impact event and can act as a head impact countermeasure. For example, the impact ribs 32 can adsorb energy in the case of head impact with the headliner 14 during an impact event. The impact ribs 32 can be formed in a direction substantially perpendicular to the longitudinal axis L (FIG. 2). Certain impact ribs 32 can include crossbars 46, which can provide for additional energy absorption.

In one example, with reference to FIG. 3, the at least one handle mounting feature 34 can be formed on the first portion 42. It should be noted that the at least one handle mounting feature 34 can be formed on both the first portion 42 and the second portion 44, if desired, based on the size of the motor vehicle 10. In this example, the at least one handle mounting feature 34 can comprise a first handle mounting feature 34a and a second handle mounting feature 34b. The first handle mounting feature 34a and the second handle mounting feature 34b can comprise a plurality of apertures 48 and a pocket 50, which can be used to couple a grab handle to the first interior retainer 20a. The grab handle can be coupled to the first interior retainer 20a and configured to extend into the passenger area 12 for use by occupants of the motor vehicle 10.

The at least one wire harness retainer 36 can comprise a plurality of tabs 52, which can be formed along a first edge 54 of the first portion 42 and second portion 44. The plurality of tabs 52 can generally be formed to extend outwardly from the first edge 54 so that a wire harness can be retained between the plurality of tabs 52 and the headliner 14.

With continued reference to FIG. 3, the at least one airbag retaining feature 38 can include at least one or a plurality of brackets 56 and at least one flange 58. The at least one airbag retaining feature 38 can be integrally formed with the first interior retainer 20a. The brackets 56 can be positioned adjacent to a second edge 60 of the first portion 42 and the second portion 44. The second edge 60 can be generally opposite the first edge 54. With reference to FIG. 2, the brackets 56 can project outwardly from a surface S of the first portion 42 and the second portion 44. The brackets 56 can be configured to mate with a clip 62 to couple the airbag 30 to the first interior retainer 20a. In one example, the clip 62 can comprise a hooded clip, such as the hooded clip disclosed in commonly owned U.S. patent application Ser. No. ______, filed on ______ and entitled “Hooded Clip” (Attorney Docket No. 707872US1), which is incorporated herein by reference and will not be discussed in great detail herein. Briefly, however, the clip 62 can receive a strap 64 of the airbag 30 to couple the airbag 30 to the first interior retainer 20a.

With reference to FIG. 3, the at least one flange 58 can comprise a first flange 58a and a second flange 58b. The first flange 58a can be coupled to the second edge 60 of the first portion 42 and the second flange 58b can be coupled to the second edge 60 of the second portion 44. A portion of the airbag 30 can be positioned under the first flange 58a and the second flange 58b to assist in retaining the airbag 30 between the first interior retainer 20a and the headliner 14 (FIG. 2). In other words, a portion of the airbag 30 can be received between the first flange 58a, the second flange 58b and the headliner 14 to couple the airbag 30 to the first interior retainer 20a.

The inflator cover 40 can be coupled to the first portion 42. In one example, the inflator cover 40 can be positioned over the inflator 28 and secured to the first portion 42 via one or more mechanical fasteners, such as screws. It should be noted, however, that the inflator cover 40 can be snap-fit onto the first portion 42, or the inflator cover 40 can be integrally formed with the first portion 42, if desired. The inflator cover 40 can include impact ribs 40a, which can assist in absorbing energy during an impact event. The inflator cover 40 can also include a flange 66, which can be positioned about a portion of the airbag 30. The inflator cover 40 can cooperate with the directional rib 41 to guide the inflation of the airbag 30 toward a lower, external side edge of the headliner 14, toward an interior portion of the motor vehicle 10. In this regard, the inflator cover 40 can be coupled to the headliner 14 so as to remove any gaps between the airbag 30 and the frame of the motor vehicle 10. By removing the gap, all of the force of the airbag 30 can be directed towards the headliner 14, in a direction inboard or toward an interior portion of the motor vehicle 10.

With reference to FIGS. 4 and 4A, the directional rib 41 can be formed on the first interior retainer 20a so as to be positioned between the airbag 30 and the inflator 28. Generally, the inflator 28 can be positioned above the directional rib 41 so that the directional rib 41 extends between the inflator 28 and the airbag 30. The directional rib 41 can be formed to extend longitudinally adjacent to the airbag 30 to assist in guiding the inflation of the airbag 30 towards the interior portion of the motor vehicle 10. The directional rib 41 can prevent the inflation of the airbag 30 in the direction of the inflator 28, and can direct the inflation of the airbag 30 downward, toward the lower, external edge of the headliner 14. Together, the directional rib 41 and the inflator cover 40 can cooperate to limit the volume of space around the airbag 30, so that when the airbag 30 expands, the force of the expanding airbag 30 is directed towards the headliner 14 and into the interior portion of the motor vehicle 10.

With reference to FIG. 2, in one example, in order to assemble the overhead side airbag system 16 to the headliner 14, the first portion 42 and second portion 44 of the interior retainers 20a, 20b can be coupled to the respective one of the first side 22 and the second side 24 of the headliner 14. Then, the inflators 28 can be coupled to the first portions 42. The inflator covers 40 can be coupled to the first portions 42 over the inflators 28. Next, the airbags 30 can be coupled to the interior retainers 20a, 20b so that the airbag 30 is positioned under the inflator cover 40 and adjacent to the directional rib 41. Generally, one or more straps 64 from the airbags 30 can be coupled to a respective one of the clips 62. Then, the clips 62 can be coupled to the brackets 56. The airbags 30 can be positioned under the flanges 58a, 58b and the flange 66 of the inflator covers 40.

With the overhead side airbag system 16 coupled to the interior retainers 20a, 20b, a wire harness can be positioned under the plurality of tabs 52, and grab handles can be mounted to the first handle mounting feature 34a and the second handle mounting feature 34b. Then, the headliner 14 can be coupled to a frame of the motor vehicle 10, using a plurality of body-in-white coupling apertures 68. Each of the body-in-white coupling apertures 68 can receive a suitable mechanical fastener to couple the headliner 14 to the motor vehicle 10.

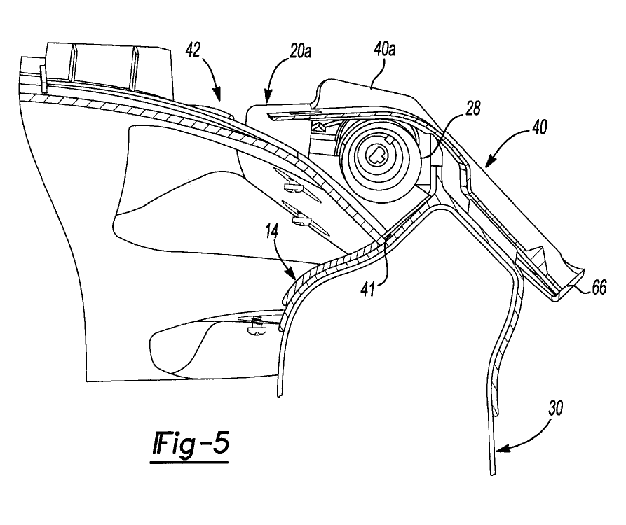

During an impact event, each of the inflators 28 can receive a signal to inflate the airbags 30. As each airbag 30 inflates, the directional rib 41 and the inflator cover 40 can guide the airbags 30 toward the lower, external side edge of the headliner 14, toward an interior portion of the motor vehicle 10. The force of the expanding airbags 30 can move the headliner 14 so that the airbags 30 can expand into the passenger area 12, as best illustrated in FIG. 5.

Thus, the interior retainers 20a, 20b can be used to couple various components of the motor vehicle 10 to the headliner 14, such as the overhead side airbag system 16. The use of the interior retainers 20a, 20b can also reduce assembly time for the motor vehicle 10, as various components can be assembled to the headliner 14 prior to coupling the headliner 14 to the motor vehicle 10. In addition, the interior retainers 20a, 20b can reduce the number of mechanical fasteners needed to couple the headliner 14 and the overhead side airbag system 16 to a body-in-white of the motor vehicle 10, which can further reduce assembly time. The interior retainers 20a, 20b can also serve to direct or guide the airbags 30 towards a lower, external side edge of the headliner 14, toward an interior portion of the motor vehicle 10.

What is claimed is:

1. An airbag deployment system for a vehicle comprising:
an airbag positioned between a vehicle frame and a headliner; and
a retainer positioned along the headliner, the retainer having a rib positioned and configured above the airbag, wherein when the airbag is deployed the rib urges the airbag away from the rib in a direction of a lower, external side edge of the headliner, toward an interior portion of the vehicle.

2. The system of claim 1, further comprising an inflator positioned between the retainer and the vehicle frame, wherein the inflator is in communication with the airbag to cause the deployment of the airbag.

3. The system of claim 2, wherein the inflator is positioned above the rib such that the rib extends between the inflator and the airbag.

4. The system of claim 1, wherein the retainer further comprises at least one airbag retaining feature for coupling the airbag to the retainer.

5. The system of claim 4, wherein the at least one airbag retaining feature further comprises a bracket, which can receive a clip to couple the airbag to the retainer.

6. The system of claim 1, wherein the retainer is injection molded.

7. The system of claim 1, wherein the retainer further comprises a first retainer and a second retainer, the first retainer positioned longitudinally along a first side of the headliner and the second retainer positioned longitudinally along an opposite, second side of the headliner.

8. The system of claim 7, wherein each of the first retainer and the second retainer further comprise at least one handle mounting feature and at least one wire harness retainer.

9. The system of claim 7, wherein each of the first retainer and the second retainer further comprise one or more impact ribs that act as a head impact countermeasure.

10. An interior roof retainer for a motor vehicle comprising:
a headliner that spans a passenger area in the motor vehicle;
at least one interior retainer coupled to the headliner so as to extend substantially along a length of the headliner, the at least one interior retainer including at least one airbag retaining feature, the at least one airbag retaining feature including at least one bracket and at least one flange;
at least one airbag capable of expanding through a portion of the headliner, a strap of the at least one airbag couplable to the at least one bracket and a portion of the at least one airbag received between the at least one flange and the headliner to couple the at least one airbag to the at least one interior retainer; and
at least one inflator that is operable to expand the at least one airbag, the at least one inflator couplable to the at least one interior retainer.

11. The interior roof retainer of claim 10, wherein the at least one interior retainer further comprises at least one handle mounting feature and at least one wire harness retainer.

12. The interior roof retainer of claim 10, wherein the at least one interior retainer further comprises one or more impact ribs that act as a head impact countermeasure.

13. The interior roof retainer of claim 10, wherein the at least one airbag retaining feature is integrally formed with the at least one interior retainer.

14. The interior roof retainer of claim 10, wherein the headliner includes a first side opposite a second side, and the at least one interior retainer further comprises a first interior retainer coupled to the first side and a second interior retainer coupled to the second side.

15. The interior roof retainer of claim 14, wherein the first interior retainer and the second interior retainer are coupled to the headliner via an adhesive.

16. The interior roof retainer of claim 15, wherein the at least one airbag comprises a first airbag and a second airbag, with the first airbag coupled to the first interior retainer and the second airbag coupled to the second interior retainer.

17. The interior roof retainer of claim 15, wherein the at least one inflator comprises a first inflator and a second inflator, with the first inflator coupled to the first interior retainer and the second inflator coupled to the second interior retainer.

18. The interior roof retainer of claim 10, further comprising at least one inflator cover, wherein the at least one inflator cover is coupled to the at least one interior retainer over the at least one inflator.

19. The interior roof retainer of claim 10, wherein retainer includes a rib positioned and configured above the at least one airbag that urges the at least one airbag away from the rib in a direction of a lower, external side edge of the headliner, toward an interior portion of the motor vehicle.
